(19) United States
(12) Patent Application Publication
(10) Pub. No.: US 2019/0240946 A1
(43) Pub. Date: Aug. 8, 2019

(54) A METHOD AND A MACHINE FOR PRODUCING A CARDBOARD STRIP FOR PACKAGING FROM A FIRST PLURALITY OF CARDBOARD SHEETS FOR PACKAGING WHICH ARE CYCLICALLY UNITED TO ONE ANOTHER

(71) Applicant: TECNOBREVETTI S.N.C. DI PONTI GIUSEPPE & BIANCONI MIRELLA, ROMA (IT)

(72) Inventor: GIUSEPPE PONTI, CERBARA-CITTA'DI CASTELLO (PG) (IT)

(21) Appl. No.: 16/340,475

(22) PCT Filed: Oct. 18, 2017
(86) PCT No.: PCT/IB2017/056484

§ 371 Date: Apr. 9, 2019

(30) Foreign Application Priority Data
Oct. 19, 2016 (IT) 102016000104887

(51) Int. Cl. B31F 5/04; B65H 37/04; B65B 41/02

(52) U.S. Cl. CPC B31F 5/04; B65H 2701/176; B65B 41/02; B65H 37/04

(57) ABSTRACT

A method for producing a cardboard strip for packaging from a first plurality of cardboard sheets for packaging which are cyclically united to one another. The method includes providing a first plurality of cardboard sheets each having a first perimeter portion extending along a first flank of the cardboard sheet and a second perimeter portion extending along the second flank of the cardboard sheet and further includes reducing the thickness of first perimeter portion and the second perimeter portion of a given cardboard sheet. The given cardboard sheet and another cardboard sheet are approximated to one another, so that the second perimeter portion of the given cardboard sheet and the first perimeter portion of the other cardboard sheet, of reduced thickness from a preceding cycle, are mutually superposed. The second perimeter portion of the given cardboard sheet and the first perimeter portion of the other cardboard sheet are affixed to one another.

### FIELD OF THE INVENTION

The present invention relates to the technical sector concerning the packaging of articles. In particular, the invention relates to a method and a machine for producing a cardboard strip for packaging from a first plurality of cardboard sheets for packaging which are cyclically united to one another.

### DESCRIPTION OF THE PRIOR ART

Machines are known for packaging articles, which for their operation must be supplied with a cardboard strip for packaging. EP 2 890 554 describes a machine of this type. This cardboard strip can be stocked in reels or in fan-folds, i.e. folded on themselves in a bellows fashion.

The cardboard strip, whether in the form of a reel or a fan-fold, is however expensive.

### SUMMARY OF THE INVENTION

The aim of the present invention consists in obviating the above-mentioned drawbacks.

The above aim is attained with a method and a machine for producing a cardboard strip for packaging from a plurality of cardboard sheets for packaging which are cyclically united to one another, according respectively to claims 1 and 7.

The cardboard strip is advantageously obtained by the union of cardboard sheets, which have a modest unitary cost and are easily available on the market. This cardboard strip can be stocked in reels or in fan-folds, i.e. folded on themselves in a bellows fashion.

### BRIEF DESCRIPTION OF THE DRAWINGS

Specific embodiments of the invention will be described in the following part of the present description, according to what is set down in the claims and with the aid of the accompanying tables of drawings, in which:

FIGS. 1, 1A, 2 are respectively a schematic view from above, from below and lateral of a cardboard sheet;

FIG. 2A is the same view as in FIG. 2 after the steps of reducing the thickness of parts of the cardboard sheet have been carried out according to the method and the machine of the present invention;

FIG. 3 is a schematic lateral view of three cardboard sheets which have been united to one another and on which the steps of reducing the thickness have been carried out;

FIG. 4 is a perspective view of the machine of the present invention, during a first operating step;

FIG. 5 is a view in vertical section of the machine of FIG. 4, during the first operating step;

FIG. 5A is a view along the same vertical section as in FIG. 5, but during a second operating step;

FIG. 5B is a larger-scale view of detail K of FIG. 5A;

FIG. 6 is a perspective larger-scale view of a part of the machine of FIG. 4, during a third operating step;

FIG. 7 is a perspective larger-scale view of the same part of the machine of FIG. 6, during a fourth operating step;

FIGS. 8 and 9 are vertical section views of a part of the machine of FIG. 7, during the fourth operating step, respectively along planes that are perpendicular to one another;

FIGS. 8A and 8B are respectively larger-scale views of detail J and W of FIG. 8;

FIG. 10 is a perspective view of the machine of FIG. 4, during a fifth operating step.

### DESCRIPTION OF THE PREFERRED EMBODIMENTS

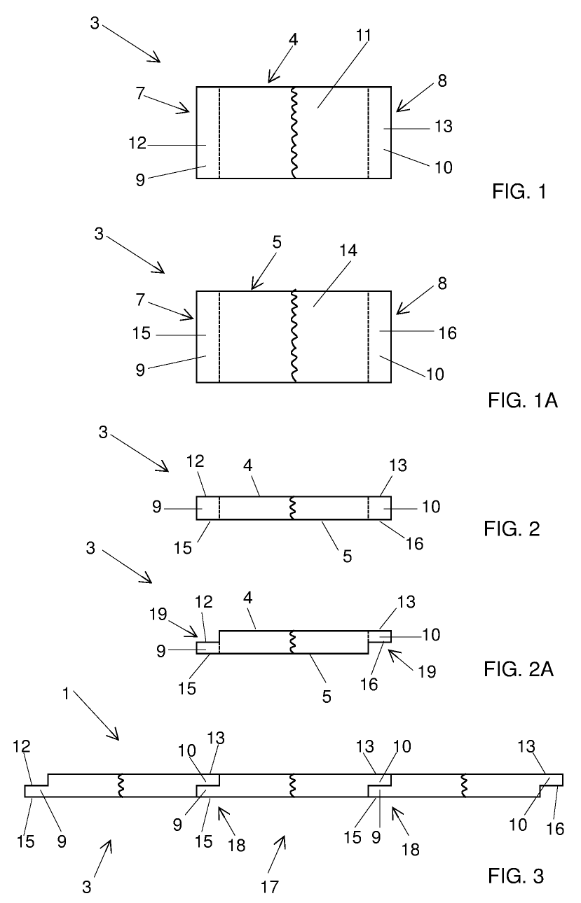

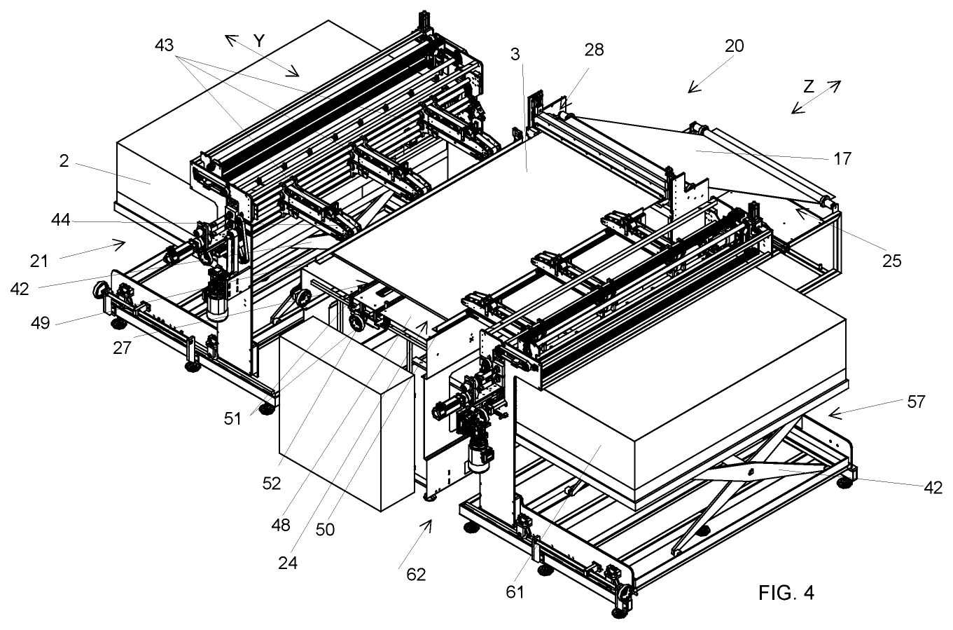

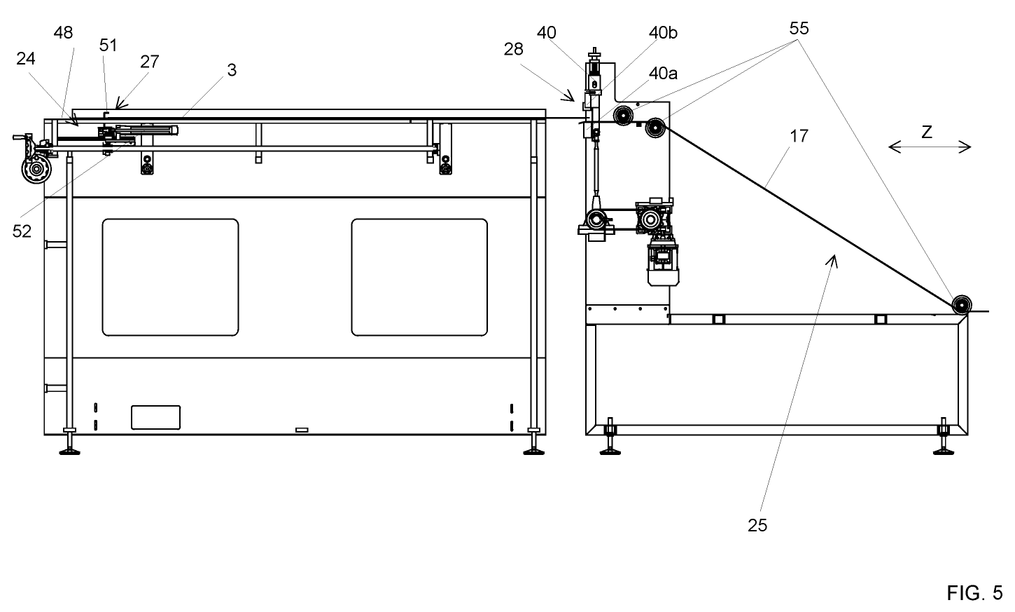

With reference to FIGS. 1-3, the method for producing a cardboard strip (1) for packaging from a first plurality of cardboard sheets (2) for packaging which are cyclically united to one another, object of the present invention, comprises a step of providing a first plurality of cardboard sheets (2) for packaging, wherein each cardboard sheet (3, 17) of the first plurality of cardboard sheets (2) comprises: a first main surface (4) (FIG. 1) and a second main surface (5) (FIG. 1A) which are opposite one another, a reciprocal distance thereof defines a first thickness of the cardboard sheet (3, 17); a first flank (7); a second flank (8) opposite the first flank (7); a first perimeter portion (9) which extends along the first flank (7) of the cardboard sheet (3, 17); and a second perimeter portion (10) which develops along the second flank (8) of the cardboard sheet (3, 17); wherein the first main surface (4) comprises in turn a first central surface (11), a first perimeter surface (12) which is a part of the first perimeter portion (9), and a second perimeter surface (13) which is a part of the second perimeter portion (10); and wherein the second main surface (5) comprises in turn a second central surface (14), a third perimeter surface (15) which is a part of the first perimeter portion (9), and a fourth perimeter surface (16) which is a part of the second perimeter portion (10) (FIGS. 1, 1A, 2). Further, the method cyclically carries out the following steps (FIGS. 2A and 3): reducing the thickness of the first perimeter portion (9) of a cardboard sheet (3) of the first plurality of cardboard sheets (2), so that the third perimeter surface (15) of the cardboard sheet (3) and the first perimeter surface (12) of the cardboard sheet (3) near one another (FIG. 2A); reducing the thickness of the second perimeter portion (10) of the cardboard sheet (3), so that the second perimeter surface (13) of the cardboard sheet (3) and the fourth perimeter surface (16) of the cardboard sheet (3) near one another (FIG. 2A); nearing the cardboard sheet (3) and another cardboard sheet (17) of the first plurality of cardboard sheets (2) to one another (FIG. 3), so that the second perimeter portion (10) of the cardboard sheet (3) and the first perimeter portion (9) of the other cardboard sheet (17), the thickness of which first perimeter portion (9) of the other cardboard sheet (17) has been reduced in a preceding cycle, are mutually superposed, and then fixing the second perimeter portion (10) of the cardboard sheet (3) and the first perimeter portion (9) of the other cardboard sheet (17) to one another so that the cardboard sheet (3) and the other cardboard sheet (17) are united to one another.

The method of the invention carries out the steps cyclically. In this matter reference was made in the foregoing to a generic cycle and a cardboard sheet (3) of the first plurality of cardboard sheets (2); reference was also made to another cardboard sheet (17) which has been subjected to the same steps, but in a preceding cycle. The cardboard sheet (3) and another cardboard sheet (17) might be referred to as the “first cardboard sheet (3)” and the “second cardboard sheet (17)” respectively.

It is not necessary to perform in the above-described order the steps of: reducing the thickness of the first perimeter portion (9) of the cardboard sheet (3), reducing the thickness of the second perimeter portion (10) of the cardboard sheet (3) and nearing the cardboard sheet (3) and the other cardboard sheet (17) to one another.

Instead, it is necessary for the step of fixing the second perimeter portion (10) of the cardboard sheet (3) and the first perimeter portion (9) of the other cardboard sheet (17) to one another is carried out following the step of nearing the cardboard sheet (3) and the other cardboard sheet (17) to one another.

Generally, once the thickness of the first perimeter portion (9) of the cardboard sheet (3) has been reduced, the first perimeter surface (12) of the cardboard sheet (3) can be dealigned (FIG. 2A) to the first central surface (11) of the cardboard sheet (3) and the third perimeter surface (15) of the cardboard sheet (3) can be dealigned (this case is not illustrated) to the second central surface (14) of the cardboard sheet (3). Likewise, once the thickness of the second perimeter portion (10) of the cardboard sheet (3) has been reduced, the second perimeter surface (13) of the cardboard sheet (3) can be dealigned (this case is not illustrated) to the first central surface (11) of the cardboard sheet (3) and the fourth perimeter surface (16) of the cardboard sheet (3) can be dealigned (FIG. 2A) to the second central surface (14) of the cardboard sheet (3).

According to a preferred embodiment, illustrated in FIG. 2A, the step of reducing the thickness of the first perimeter portion (9) of the cardboard sheet (3) is such that the third perimeter surface (15) of the cardboard sheet (3) remains substantially aligned to the second central surface (14) of the cardboard sheet (3) and the first perimeter surface (12) of the cardboard sheet (3) nears the third perimeter surface (15) of the cardboard sheet (3); the step of reducing the thickness of the second perimeter portion (10) of the cardboard sheet (3) is such that the second perimeter surface (13) of the cardboard sheet (3) remains substantially aligned to the first central surface (11) of the cardboard sheet (3) and that the fourth perimeter surface (16) of the cardboard sheet (3) nears the second perimeter surface (13) of the cardboard sheet (3); the step of reducing the thickness of the first perimeter portion (9) of the cardboard sheet (3) and the step of reducing the thickness of the second perimeter surface (10) of the cardboard sheet (3) are such that the first perimeter portion (9) and the second perimeter portion (10) have a same width, so that when the cardboard sheet (3) and the other cardboard sheet (17) near one another, the second perimeter portion (10) of the cardboard sheet (3) and the first perimeter portion (9) of the other cardboard sheet (17) are substantially completely superposed on one another; the step of reducing the thickness of the first perimeter portion (9) of the cardboard sheet (3) and the step of reducing the thickness of the second perimeter portion (10) of the cardboard sheet (3) are such that when the cardboard sheet (3) and the other cardboard sheet (17) are neared to one another, then the fourth perimeter surface (16) of the cardboard sheet (3) and the first perimeter surface (12) of the other cardboard sheet (17) contact one another, so that at the region (18) in which the second perimeter portion (10) of the cardboard sheet (3) and the first perimeter portion (9) of the other cardboard sheet (17) are superposed on one another the thickness is equal to the first thickness (FIG. 3).

The cardboard strip (1) obtained in this way advantageously has a thickness that is substantially constant along the length thereof and equal to the first thickness: in fact, the thickness is equal to the first thickness including in the region (18) in which the second perimeter portion (10) of the cardboard sheet (3) and the first perimeter portion (9) of the other cardboard sheet (17) to one another. Further, the cardboard strip (1) also maintains its continuity at the region (18), in the sense that there is a continuity between the second perimeter surface (13) of the cardboard sheet (3) and the first central surface (11) of the other cardboard sheet (17) and in that there is a continuity between the second central surface (14) of the cardboard sheet (3) and the third perimeter surface (15) of the other cardboard sheet (17) (FIG. 3).

Starting from the preferred embodiment described in the foregoing (FIG. 2A), the step of reducing the thickness of the first perimeter portion (9) of the cardboard sheet (3) and the step of reducing the thickness of the second perimeter portion (10) of the cardboard sheet (3) are preferably such that when the cardboard sheet (3) and the other cardboard sheet (17) are neared to one another, then the fourth perimeter surface (16) of the cardboard sheet (3) and the first perimeter surface (12) of the other cardboard sheet (17) entirely contact one another. In this case, the contact between the above-mentioned surfaces extends for the whole width of the second perimeter portion (10) of the cardboard sheet (3) and the first perimeter portion (9) of the other cardboard sheet (17), with the advantage that the cardboard strip (1) obtained in this way, at the region (18) in which the second perimeter portion (10) of the cardboard sheet (3) and the first perimeter portion (9) of the other cardboard sheet (17) are superposed on one another, is not subject to substantial alterations of the mechanical characteristics thereof. In other words, the mechanical characteristics (e.g. resistance to compression, resistance to traction) of the cardboard strip (1) are thus maintained unvaried along the whole length thereof, including at the above-mentioned region (18).

The step of reducing the thickness of the first perimeter portion (9) of the cardboard sheet (3) is preferably such as to form a step (19) between the first central surface (11) and the first perimeter surface (12) (FIG. 2A).

The step of reducing the thickness of the second perimeter portion (10) of the cardboard sheet (3) is preferably such as to form a step (19) between the second central surface (14) and the fourth perimeter surface (16) (FIG. 2A).

The step of reducing the thickness of the first perimeter portion (9) of the cardboard sheet (3) is preferably such that the first perimeter portion (9) has a constant thickness. This thickness is preferably equal to half the first thickness.

The step of reducing the thickness of the second perimeter portion (10) of the cardboard sheet (3) is preferably such that the second perimeter portion (10) has a constant thickness. This thickness is preferably equal to half the first thickness.

The step of reducing the thickness of the first perimeter portion (9) of the cardboard sheet (3) and the step of reducing the thickness of the second perimeter portion (10) of the cardboard sheet (3) are preferably such that when the cardboard sheet (3) and the other cardboard sheet (17) are neared to one another a form coupling is established. In other words, the contact profile of the first perimeter portion (9) and the contact profile of the second perimeter portion (10) are complementary and matching with respect to one another.

The steps of reducing the thickness of the first perimeter portion (9) of the cardboard sheet (3) and reducing the thickness of the second perimeter portion (10) of the cardboard sheet (3) can be carried out in various ways, such as the removing of material and the crushing.

The step of reducing the thickness of the first perimeter portion (9) of the cardboard sheet (3) preferably comprises a crushing of the first perimeter portion (9) of the cardboard sheet (3); the step of reducing the thickness of the second perimeter portion (10) of the cardboard sheet (3) comprises a crushing of the second perimeter portion (10) of the cardboard sheet (3).

The crushing of the cardboard sheet advantageously produces no waste, which comprises dust and fragments of cardboard which would require an efficient collection and removal system (for example by means of aspiration).

The step of fixing the second perimeter portion (10) of the cardboard sheet (3) and the first perimeter portion (9) of the other cardboard sheet (17) to one another preferably comprises a gluing of the second perimeter portion (10) of the cardboard sheet (3) and of the first perimeter portion (9) of the other cardboard sheet (17) to one another.

The gluing of the second perimeter portion (10) of the cardboard sheet (3) and the first perimeter portion (9) of the other cardboard sheet (17) to one another preferably comprises a step of applying glue on the first perimeter surface (12) of the cardboard sheet (3) or on the fourth perimeter surface (16) of the cardboard sheet (3); the step of applying glue on the first perimeter surface (12) of the cardboard sheet (3) or on the fourth perimeter surface (16) of the cardboard sheet (3) is carried out: following the steps of reducing the thickness of the first perimeter portion (9) of the cardboard sheet (3) and reducing the thickness of the second perimeter portion (10) of the cardboard sheet (3); and prior to the step of nearing the cardboard sheet (3) and the other cardboard sheet (17) to one another, so that the second perimeter portion (10) of the cardboard sheet (3) is superposed on the first perimeter portion (9) of the other cardboard sheet (17).

There follows a description of a machine (20) for producing a cardboard strip (1) for packaging from a first plurality of cardboard sheets (2) for packaging which are cyclically united to one another, also an objective of the present invention, in actuation of the above-described method. Refer to figures from 4 to 10.

The machine (20) comprises a first store (21) for containing the first plurality of cardboard sheets (2) for packaging; first reducing means (22) of the thickness which reduce the thickness of the first perimeter portion (9) of the cardboard sheet (3) coming from the first store (21), so that the first perimeter surface (12) of the cardboard sheet (3) and the third perimeter surface (15) of the cardboard sheet (3) near one another; second reducing means of the thickness (23) which reduce the thickness of the second perimeter portion (10) of the cardboard sheet (3) coming from the first store (21), so that the second perimeter surface (13) of the cardboard sheet (3) and the fourth perimeter surface (16) of the cardboard sheet (3) near one another; a first support (24) which restingly receives the cardboard sheet (3) coming from the first store (21); a second support (25); first pick-up and transfer means (26) which pick up the cardboard sheet (3) from the first store (21) and transfer the cardboard sheet (3) onto the first support (24); pusher means (27) for pushing the cardboard sheet (3), when the cardboard sheet (3) is resting on the first support (24), so as to near the second perimeter portion (10) of the cardboard sheet (3) to the first perimeter portion (9) of the other cardboard sheet (17), when the other cardboard sheet (17) is arranged on the second support (25). The first support (24) and the second support (25) are arranged with respect to one another so that when the pusher means (27) near the cardboard sheet (3) to the other cardboard sheet (17) then the second perimeter portion (10) of the cardboard sheet (3) and the first perimeter portion (9) of the other cardboard sheet (17) are superposed on one another. The machine (20) further comprises: fixing means (28) for fixing the second perimeter portion (10) of the cardboard sheet (3) and the first perimeter portion (9) of the other cardboard sheet (17) to one another.

The first reducing means (22) of the thickness preferably comprise a first pair of counter-rotating rollers (29), and wherein the second reducing means (23) of the thickness comprise a second pair of counter-rotating rollers (30).

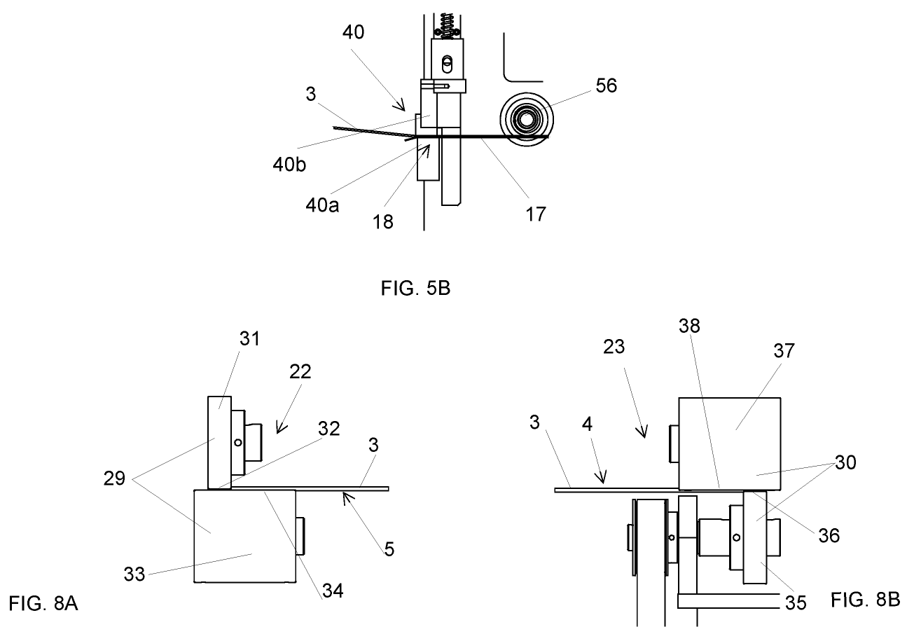

In a preferred embodiment: the first pair of counter-rotating rollers (29) comprises (FIG. 8A) a first crushing roller (31) which comprises a first lateral surface (32) and a first abutting roller (33) which comprises a second lateral surface (34), the first abutting roller (33) being arranged so that the second lateral surface (34) is tangential to the second main surface (5) of the cardboard sheet (3) coming from the first store (21), the first crushing roller (31) and the first abutting roller (33) being arranged with respect to one another at such a distance that the first perimeter portion (9) of the cardboard sheet (3) is crushed so that the first perimeter surface (12) of the cardboard sheet (3) nears the third perimeter surface (15) of the cardboard sheet (3) while the third perimeter surface (15) of the cardboard sheet (3) remains substantially aligned to the second central surface (14) of the cardboard sheet (3); the second pair of counter-rotating rollers (30) comprises (FIG. 8B) a second crushing roller (35) which comprises a third lateral surface (36) and a second abutting roller (37) which comprises a fourth lateral surface (38), the second abutting roller (37) being arranged so that the fourth lateral surface (38) is tangential to the first main surface (4) of the cardboard sheet (3) coming from the first store (21), the second crushing roller (35) and the second abutting roller (37) being arranged with respect to one another at such a distance that the second perimeter portion (10) of the cardboard sheet (3) is crushed so that the fourth perimeter surface (16) of the cardboard sheet (3) nears the second perimeter surface (13) of the cardboard sheet (3) while the second perimeter surface (13) of the cardboard sheet (3) remains substantially aligned to the first central surface (11) of the cardboard sheet (3); the first lateral surface (32) of the first crushing roller (31) and the third lateral surface (36) of the second crushing roller (35) have between them a width (preferably the same width) so that respectively the first perimeter portion (9) of the cardboard sheet (3) and the second perimeter portion (10) of the cardboard sheet (3) have a same width between them; the sum of the distance between the first lateral surface (32) of the first crushing roller (31) and the second lateral surface (34) of the first abutting roller (33) and of the distance between the third lateral surface (36) of the second crushing roller (35) and the fourth lateral surface (38) of the second abutting roller (37) is substantially equal to the first thickness.

The cardboard strip (1) obtained in this way advantageously has a thickness that is substantially constant along the length thereof and equal to the first thickness: in fact, the thickness is equal to the first thickness including in the region (18) in which the second perimeter portion (10) of the cardboard sheet (3) and the first perimeter portion (9) of the other cardboard sheet (17) superpose on one another. Further, the cardboard strip (1) also maintains its continuity at the region (18), in the sense that there is a continuity between the second perimeter surface (13) of the cardboard sheet (3) and the first central surface (11) of the other cardboard sheet (17) and in that there is a continuity between the second central surface (14) of the cardboard sheet (3) and the third perimeter surface (15) of the other cardboard sheet (17) (FIG. 3).

Further, with the reduction in thickness of the first perimeter portion (9) of the cardboard sheet (3) a step (19) is formed between the first central surface (11) and the first perimeter surface (12). Likewise, with the reduction in thickness of the second perimeter portion (10) of the cardboard sheet (3) a step (19) is formed between the second central surface (14) and the fourth perimeter surface.

It should also be added that the step of nearing the cardboard sheet (3) and the other cardboard sheet (17) to one another determines a form coupling. In this sense, the contact profile of the first perimeter portion (9) and the contact profile of the second perimeter portion (10) are complementary and matching with respect to one another.

The fixing means (28) preferably comprise: a gluing device (39) for applying glue on the first perimeter surface (12) of the cardboard sheet (3) or on the fourth perimeter surface (16) of the cardboard sheet (3); and a press (40) which is arranged for pressing the second perimeter portion (10) of the cardboard sheet (3) and the first perimeter portion (9) of the other cardboard sheet (17) to one another when they are superposed on one another and after depositing the glue, with the aim of gluing the second perimeter portion (10) of the cardboard sheet (3) and the first perimeter portion (9) of the other cardboard sheet (17) to one another so that the cardboard sheet (3) and the other cardboard sheet (17) are united to one another.

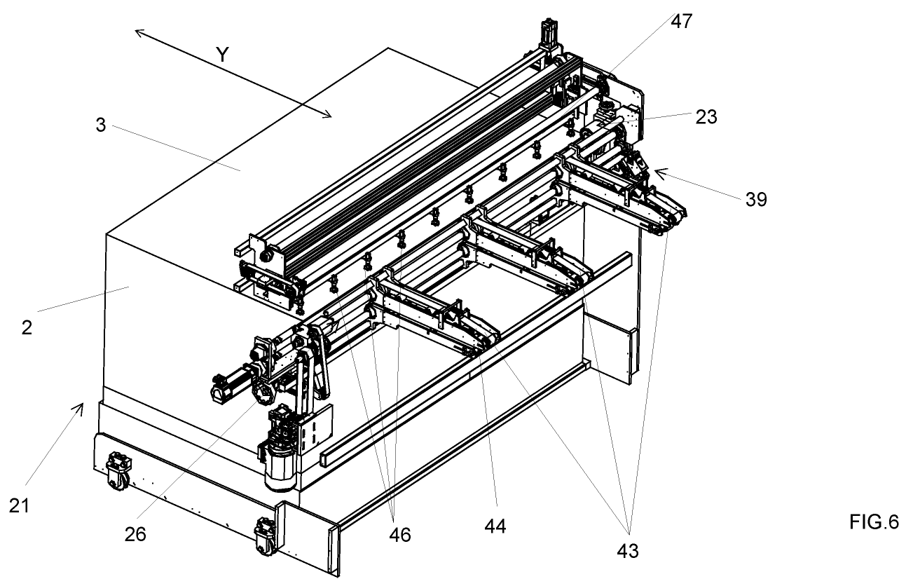

The press (40) has the function of guaranteeing the gluing of the first perimeter portion (9) and the second perimeter portion (10) to one another. Further, the press (40) advantageously enables regulating the thickness of the cardboard strip (1) in the region (18) in which the second perimeter portion (10) of the cardboard sheet (3) and the first perimeter portion (9) of the other cardboard sheet (17) are superposed on one another, for example in such a way that the overall thickness is equal to the first thickness; to obtain this it is sufficient for the plates of the press (40) to near one another during the compression step by a distance equal to the first distance. See FIGS. 5, 5A, 5B.

The gluing device (39) is preferably arranged upstream of the first support (24) and the first reducing means (22) of the thickness and the second reducing means (23) of the thickness are arranged upstream of the gluing device (39).

In particular, the first pair of counter-rotating rollers (29) and the second pair of counter-rotating rollers (30) are arranged upstream of the gluing device (39).

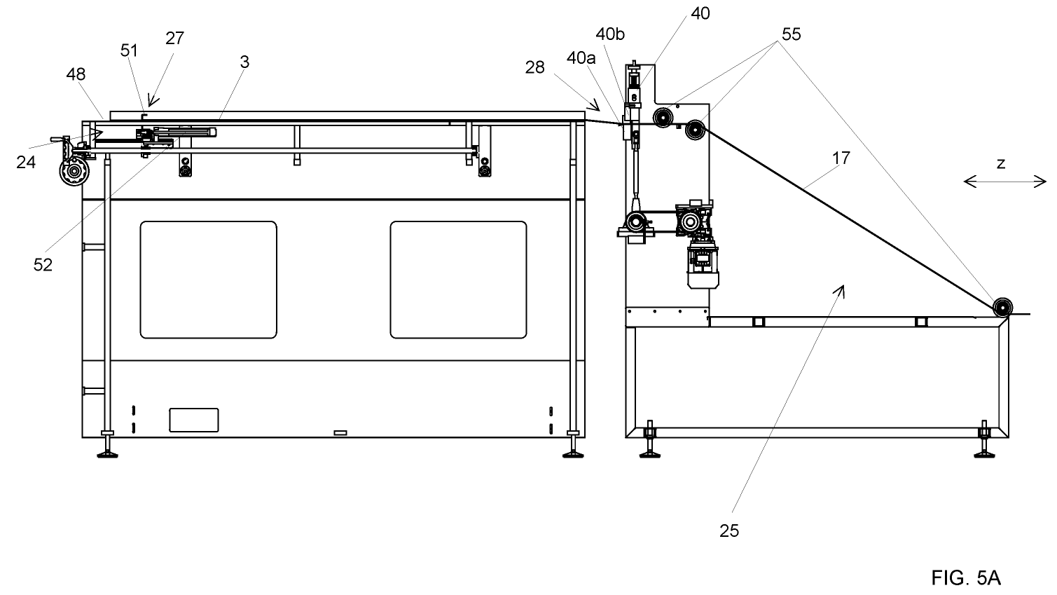

The first store (21) (FIGS. 4, 6, 7, 10) can comprise a raising device (42) (for example a pantograph) for supporting and lifting the first plurality of cardboard sheets (2) contained and stacked there one upon the others, which raising device (42) makes available, on outlet from the first store (21), each cardboard sheet (3) of the first plurality of cardboard sheets (2) always at a same height.

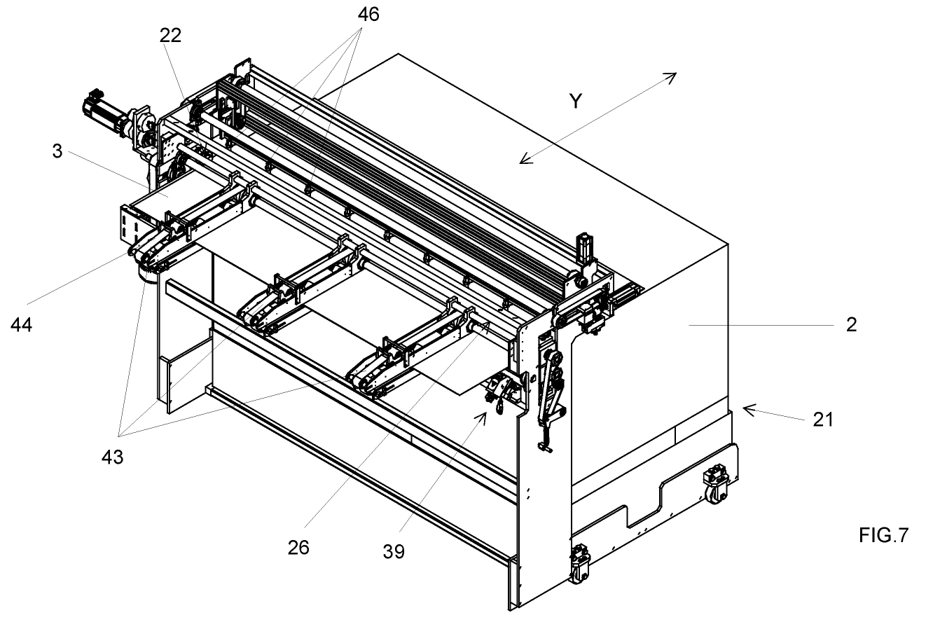

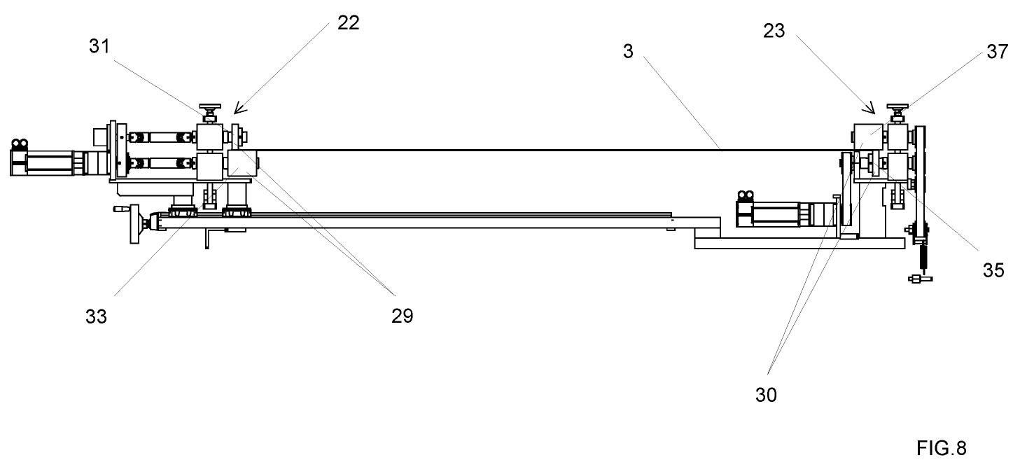

The first pick-up and transfer means (26) can comprise a plurality (43) of pairs of conveyor belts (44) arranged so as to release each cardboard sheet (3) on the first support (24), wherein each pair of conveyor belts (44) comprises two conveyor belts that are opposite one another; a depression source; a plurality of suction cups (46) which are connected to the depression source for picking up each cardboard sheet (3) arranged at the outlet of the first store (21); a transfer arm (47) which bears the plurality of suction cups (46) (FIG. 6) which is vertically mobile, for raising each cardboard sheet (3) in outlet from the first store (21), and which is transversally mobile along a first advancement direction (Y) for bringing each cardboard sheet (3) towards the first pair of counter-rotating rollers (29) and the second pair of counter-rotating rollers (30) (see FIGS. 6, 7).

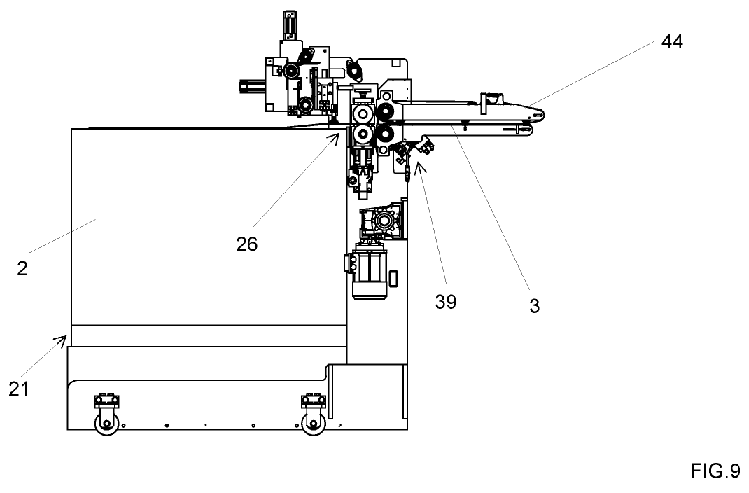

In the embodiment illustrated in the figures (in particular see FIG. 9), the plurality (43) of pairs of conveyor belts (44) is arranged downstream of the first pair di counter-rotating rollers (29) and the second pair of counter-rotating rollers (30).

The gluing device (39) is preferably arranged (FIG. 7) in such a way as to apply glue on the fourth perimeter surface (16) of each cardboard sheet (3). In this case the machine (20) can be configured so that each cardboard sheet (3) is released on the first support (24) in such a way that the relative second perimeter portion (10) projects from the first support (24). This is to prevent the glue applied on the fourth perimeter surface (16) from touching the first support plane, comprising the functioning of the machine (20).

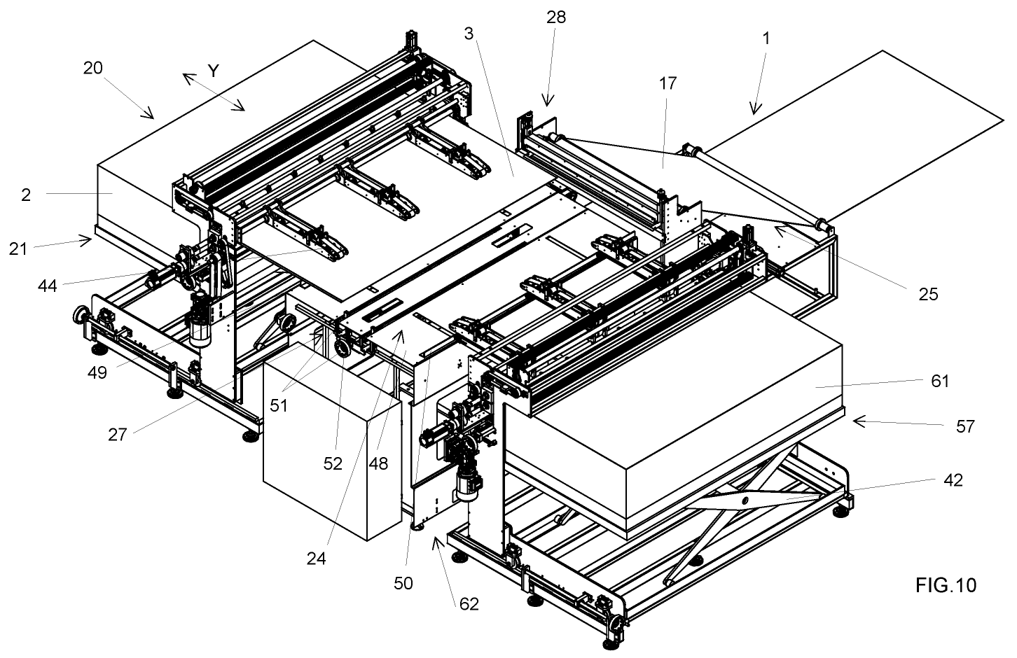

In turn, the first support (24) can comprise a rest plane (48) fixed to the frame (62) (see FIGS. 4, 10).

The machine (20) can further comprise a first guide abutment (49) and a second guide abutment (50) which are fixed to the rest plane (48) so as to be opposite one another and for guiding the cardboard sheet (3), when it is resting on the rest plane (48), along a second advancement direction (Z). The first guide abutment (49) and the second guide abutment (50) can each be an L-shaped profiled member (see FIG. 4).

The pusher means (27) can comprise one or more pusher teeth (51) (see for example FIG. 10 in which two are illustrated) which are mobile along the rest plane (48), parallel to the second advancement direction (Z), for pushing the cardboard sheet (3), when the cardboard sheet (3) is resting on the first support (24), so as to near the second perimeter portion (10) of the cardboard sheet (3) to the first perimeter portion (9) of the other cardboard sheet (17), when the other cardboard sheet (17) is arranged on the second support (25). The pusher teeth (51) can perform an outward run and a return run; in particular, during the outward run the pusher teeth (51) push the cardboard sheet (3) towards the second support (25).

With reference to FIGS. 5, 5A, the pusher means (27) can further comprise a pneumatic cylinder (52), borne by the frame (62), which actuates the pusher teeth (51).

The press (40) is arranged downstream of the first support (24) with respect to the advancing path of the cardboard sheet (3). The press (40) can comprise a first plate (40a) and a second plate (40b), which are mobile with respect to one another, in order to press between them the second perimeter portion (10) of the cardboard sheet (3) and the first perimeter portion (9) of the other cardboard sheet (17) when they are superposed on one another. The first plate (40a) can be arranged below the second plate (40b) and be solidly constrained to the frame (62), while the second plate (40b) can be mobile with respect to the first plate (40a) (see FIGS. 5, 5A, 5B).

With reference to FIGS. 5, 5A the machine (20) can comprise a plurality of idle rollers (55) which are borne by the frame (62) and which are arranged for abutting the other cardboard sheet (17).

In turn, one or more idle rollers (56) of the plurality of idle rollers (55) and the first plate (40a) of the press (40) can identify the second support (25) (see FIGS. 5, 5A).

There follows a description of a cycle of the machine (20), with reference to figures from 4 to 10. Initially the transfer arm (47) takes the plurality di suction cups (46) into contact with the first main surface (4) of a cardboard sheet (3) arranged at the output of the first store (21); subsequently, the depression source is activated and the plurality of suction cups (46) picks up the cardboard sheet (3). In other words, the plurality of suction cups (46) adheres to the cardboard sheet (3) to be picked up, see FIG. 6.

Thereafter, the transfer arm (47) is moved to bring the cardboard sheet (3) between the first crushing roller (31) and the first abutting roller (33) and between the second crushing roller (35) and the second abutting roller (37), after the depression source is deactivated. The first pair di counter-rotating rollers (29) and the second pair of counter-rotating rollers (30) therefore take the cardboard sheet (3), reduce the thickness of the first perimeter portion (9) and of the second perimeter portion (10) of the cardboard sheet (3) and at the same time transfer the cardboard sheet (3) towards the plurality (43) of pairs of conveyor belts (44) (see FIGS. 8, 8A, 8B, 9). The plurality (43) of pairs of conveyor belts (44) thus take the cardboard sheet (3) and release it on the first support plane (see FIGS. 9, 10).

As the first pair of counter-rotating rollers (29) and the second pair of counter-rotating rollers (30) progressively crush the first perimeter portion (9) and the second perimeter portion (10) (see FIG. 7), the gluing device (39) applies the glue on the fourth perimeter surface (16) at those parts of the second perimeter portion (10) which have already been crushed.

The cardboard sheet (3) is then released (see FIG. 10) to rest on the first support (24) with the relative second perimeter portion (10) projecting from the first support (24); subsequently, the cardboard sheet (3) is pushed by the pusher means (27) towards the press (40) (along the second advancement direction (Z)), see FIGS. 4, 5 in which it can be observed that the pusher teeth (51) have already also completed the return run. In proximity of the press (40), the second perimeter portion (10) of the cardboard sheet (3) superposes on the first perimeter portion (9) of the other cardboard sheet (17), which is resting on the second support (25), see FIG. 5. The press (40) guarantees the gluing of the second perimeter portion (10) of the cardboard sheet (3) and the first perimeter portion (9) of the other cardboard sheet (17) superposed on one another. Lastly, once the union between the cardboard sheet (3) and the other cardboard sheet (17) has been realised, the cardboard strip (1) is advanced along the second advancement direction (Z) for freeing the first support (24). The machine (20) can further comprise: a second store (57) which can be substantially identical to the first store (21) and which is arranged on the opposite side to the first store (21) with respect to the first support (24); third reducing means of the thickness and fourth reducing means of the thickness which can be identical respectively to the first reducing means (22) of the thickness and the second reducing means (23) of the thickness; second pick-up and transfer means which can be identical to the first pick-up and transfer means (26), and which pick up the cardboard sheet (3) from the second store (57) and transfer the cardboard sheet (3) onto the first support (24) (see FIGS. 4, 10).

The presence of the second store (57) advantageously guarantees the continuity of the operating cycle. The second store (57) can feed the machine (20) with a second plurality of cardboard sheets (61), when the machine (20) is not supplied by the first store (21), for example because the cardboard sheets in the first store (21) has run out.

A packaging system of articles, also object of the present invention, is described in the following, which comprises: a packaging machine of articles, which receives in inlet a cardboard strip (1) (not illustrated as of known type, see for example document EP 2 890 554); and the machine (20) described in the foregoing, which is arranged upstream of the packaging machine of articles, for supplying the packaging machine of articles with the cardboard strip (1).

The cardboard strip (1) is produced directly upstream of the packaging machine of articles. The commercial concern where the articles are packaged (i.e. where the packaging machine of articles is located) must therefore be provided with cardboard sheets and no longer by reels of cardboard strip or fan-folds of cardboard strips. This is advantageous for the reason that follows. Provision of the cardboard strip, whether in reel or in fanfold form, is problematic. There are in fact few producers on the market manufacturing the cardboard strips: for this reason, the distance between the company where the articles are packaged, which requires a constant supply of cardboard strips, and the company producing the cardboard strips is, on average, long and this has an effect on transport costs. With the system of the invention, the cost of transport of the cardboard sheets advantageously falls drastically, as there are on average many producers of cardboard sheets in a territory.

1. A method for producing a cardboard strip for packaging from a first plurality of cardboard sheets for packaging which are cyclically united to one another, which method:
comprises a step of providing a first plurality of cardboard sheets for packaging, wherein each cardboard sheet of the first plurality of cardboard sheets comprises: a first main surface and a second main surface which are opposite one another, a reciprocal distance thereof defines a first thickness of the cardboard sheet; a first flank; a second flank opposite the first flank; a first perimeter portion which extends along the first flank of the cardboard sheet; and a second perimeter portion which develops along the second flank of the cardboard sheet; wherein the first main surface comprises in turn a first central surface, a first perimeter surface which is a part of the first perimeter portion, and a second perimeter surface which is a part of the second perimeter portion; and wherein the second main surface comprises in turn a second central surface, a third perimeter surface which is a part of the first perimeter portion, and a fourth perimeter surface which is a part of the second perimeter portion;
and cyclically carries out following steps:
reducing the thickness of the first perimeter portion of a cardboard sheet of the first plurality of cardboard sheets, so that the third perimeter surface of the cardboard sheet and the first perimeter surface of the cardboard sheet near one another;
reducing the thickness of the second perimeter portion of the cardboard sheet, so that the second perimeter surface of the cardboard sheet and the fourth perimeter surface of the cardboard sheet near one another;
nearing the cardboard sheet and another cardboard sheet of the first plurality of cardboard sheets to one another, so that the second perimeter portion of the cardboard sheet and the first perimeter portion of the other cardboard sheet, the thickness of which first perimeter portion of the other cardboard sheet has been reduced in a preceding cycle, are mutually superposed, and then fixing the second perimeter portion of the cardboard sheet and the first perimeter portion of the other cardboard sheet to one another so that the cardboard sheet and the other cardboard sheet are united to one another.

2. The method of claim 1, wherein:
the step of reducing the thickness of the first perimeter portion of the cardboard sheet is such that the third perimeter surface of the cardboard sheet remains substantially aligned to the second central surface of the cardboard sheet and the first perimeter surface of the cardboard sheet nears the third perimeter surface of the cardboard sheet;
the step of reducing the thickness of the second perimeter portion of the cardboard sheet is such that the second perimeter surface of the cardboard sheet remains substantially aligned to the first central surface of the cardboard sheet and that the fourth perimeter surface of the cardboard sheet nears the second perimeter surface of the cardboard sheet;
the step of reducing the thickness of the first perimeter portion of the cardboard sheet and the step of reducing the thickness of the second perimeter surface of the cardboard sheet are such that the first perimeter portion and the second perimeter portion have a same width, so that when the cardboard sheet and the other cardboard sheet near one another, the second perimeter portion of the cardboard sheet and the first perimeter portion of the other cardboard sheet are substantially completely superposed on one another;
the step of reducing the thickness of the first perimeter portion of the cardboard sheet and the step of reducing the thickness of the second perimeter portion of the cardboard sheet are such that when the cardboard sheet and the other cardboard sheet are neared to one another, then the fourth perimeter surface of the cardboard sheet and the first perimeter surface of the other cardboard sheet contact one another, so that at the region in which the second perimeter portion of the cardboard sheet and the first perimeter portion of the other cardboard sheet are superposed on one another the thickness is equal to the first thickness.

3. The method of claim 2, wherein: the step of reducing the thickness of the first perimeter portion of the cardboard sheet and the step of reducing the thickness of the second perimeter portion of the cardboard sheet are such that when the cardboard sheet and the other cardboard sheet are neared to one another, then the fourth perimeter surface of the cardboard sheet and the first perimeter surface of the other cardboard sheet entirely contact one another.

4. The method of claim 1, wherein: the step of reducing the thickness of the first perimeter portion of the cardboard sheet comprises a crushing of the first perimeter portion of the cardboard sheet; the step of reducing the thickness of the second perimeter portion of the cardboard sheet comprises a crushing of the second perimeter portion of the cardboard sheet.

5. The method of claim 1, wherein the step of fixing the second perimeter portion of the cardboard sheet and the first perimeter portion of the other cardboard sheet to one another comprises a gluing of the second perimeter portion of the cardboard sheet and of the first perimeter portion of the other cardboard sheet to one another.

6. The method of claim 5, wherein:
the gluing of the second perimeter portion of the cardboard sheet and the first perimeter portion of the other cardboard sheet to one another comprises a step of applying glue on the first perimeter surface of the cardboard sheet or on the fourth perimeter surface of the cardboard sheet;
the step of applying glue on the first perimeter surface of the cardboard sheet or on the fourth perimeter surface of the cardboard sheet is done: following the steps of reducing the thickness of the first perimeter portion of the cardboard sheet and reducing the thickness of the second perimeter portion of the cardboard sheet; and prior to the step of nearing the cardboard sheet and the other cardboard sheet to one another, so that the second perimeter portion of the cardboard sheet is superposed on the first perimeter portion of the other cardboard sheet.

7. A machine for producing a cardboard strip for packaging from a first plurality of cardboard sheets for packaging which are cyclically united to one another, in actuation of the method of claim 1, comprising:
a first store for containing the first plurality of cardboard sheets for packaging;
first reducing means of the thickness which reduce the thickness of the first perimeter portion of the cardboard sheet coming from the first store, so that the first perimeter surface of the cardboard sheet and the third perimeter surface of the cardboard sheet near one another;
second reducing means of the thickness which reduce the thickness of the second perimeter portion of the cardboard sheet coming from the first store, so that the second perimeter surface of the cardboard sheet and the fourth perimeter surface of the cardboard sheet near one another;
a first support which restingly receives the cardboard sheet coming from the first store;
a second support;
first pick-up and transfer means which pick up the cardboard sheet from the first store and transfer the cardboard sheet onto the first support;
pusher means for pushing the cardboard sheet, when the cardboard sheet is resting on the first support, so as to near the second perimeter portion of the cardboard sheet to the first perimeter portion of the other cardboard sheet, when the other cardboard sheet is arranged on the second support;
the first support and the second support being arranged with respect to one another so that when the pusher means near the cardboard sheet to the other cardboard sheet then the second perimeter portion of the cardboard sheet and the first perimeter portion of the other cardboard sheet are superposed on one another;
fixing means for fixing the second perimeter portion of the cardboard sheet and the first perimeter portion of the other cardboard sheet to one another.

8. The machine of claim 7, wherein: the first reducing means of the thickness comprise a first pair of counter-rotating rollers, and wherein the second reducing means of the thickness comprise a second pair of counter-rotating rollers.

9. The machine of claim 8, wherein:
the first pair of counter-rotating rollers comprises a first crushing roller which comprises a first lateral surface and a first abutting roller which comprises a second lateral surface, the first abutting roller being arranged so that the second lateral surface is tangential to the second main surface of the cardboard sheet coming from the first store, the first crushing roller and the first abutting roller being arranged with respect to one another at such a distance that the first perimeter portion of the cardboard sheet is crushed so that the first perimeter surface of the cardboard sheet nears the third perimeter surface of the cardboard sheet while the third perimeter surface of the cardboard sheet remains substantially aligned to the second central surface of the cardboard sheet;
the second pair of counter-rotating rollers comprises a second crushing roller which comprises a third lateral surface and a second abutting roller which comprises a fourth lateral surface, the second abutting roller being arranged so that the fourth lateral surface is tangential to the first main surface of the cardboard sheet coming from the first store, the second crushing roller and the second abutting roller being arranged with respect to one another at such a distance that the second perimeter portion of the cardboard sheet is crushed so that the fourth perimeter surface of the cardboard sheet nears the second perimeter surface of the cardboard sheet while the second perimeter surface of the cardboard sheet remains substantially aligned to the first central surface of the cardboard sheet;
the first lateral surface of the first crushing roller and the third lateral surface of the second crushing roller have between them a width so that respectively the first perimeter portion of the cardboard sheet and the second perimeter portion of the cardboard sheet have a same width between them;
the sum of the distance between the first lateral surface of the first crushing roller and the second lateral surface of the first abutting roller and of the distance between the third lateral surface of the second crushing roller and the fourth lateral surface of the second abutting roller is substantially equal to the first thickness.

10. The machine of claim 7, wherein the fixing means comprise: a gluing device for applying glue on the first perimeter surface of the cardboard sheet or on the fourth perimeter surface of the cardboard sheet; and a press which is arranged for pressing the second perimeter portion of the cardboard sheet and the first perimeter portion of the other cardboard sheet to one another when they are superposed on one another and after depositing the glue, with the aim of gluing the second perimeter portion of the cardboard sheet and the first perimeter portion of the other cardboard sheet to one another so that the cardboard sheet and the other cardboard sheet are united to one another.

11. The machine of claim 10, wherein: the gluing device is arranged upstream of the first support and wherein the first reducing means of the thickness and the second reducing means of the thickness are arranged upstream of the gluing device.

12. A packaging system of articles, comprising:
a packaging machine of articles, which receives in inlet a cardboard strip;
and the machine according to claim 7, which is arranged upstream of the packaging machine of articles, for supplying the packaging machine of articles with the cardboard strip.
